(19) United States
(12) Patent Application Publication
(10) Pub. No.: US 2013/0320252 A1
(43) Pub. Date: Dec. 5, 2013

(54) CONTROL VALVE ASSEMBLY

(71) Applicants: David C. Hageman, Chagrin Falls, OH (US); Richard L. Dudman, Euclid, OH (US)

(72) Inventors: David C. Hageman, Chagrin Falls, OH (US); Richard L. Dudman, Euclid, OH (US)

(73) Assignee: EGC ENTERPRISES, INC., Chardon, OH (US)

(21) Appl. No.: 13/985,407

(22) PCT Filed: Feb. 17, 2012
(86) PCT No.: PCT/US2012/025575

§ 371 Date: Aug. 14, 2013

Related U.S. Application Data
(60) Provisional application No. 61/443,794, filed on Feb. 17, 2011.

(51) Int. Cl. F16K 11/07

(52) U.S. Cl. CPC F16K 11/0712
USPC 251/324

(57) ABSTRACT

A flow control valve and method for controlling fluid flow includes a valve housing defining a valve chamber. A port member mounted within the valve chamber receives a reciprocally movable piston/spool assembly. The assembly is engageable with a valve seat for blocking fluid flow through the chamber. The assembly includes a piston body defining an annular recess for receiving an annular seal and a compression bonnet received by the piston body which is operatively engageable with the annular seal. When the assembly is not engaging its associated valve seat, the seal is relaxed and thus reciprocal movement between the assembly and the port member is not substantially hindered or resisted.

### RELATED APPLICATIONS

This application claims priority to U.S. Provisional Application No. 61/443,794, filed Feb. 17, 2011, the entirety of which is incorporated herein by reference.

### TECHNICAL FIELD

The present invention relates generally to fluid flow control and, in particular, to an improved flow control valve assembly.

### BACKGROUND

Control valves of the type to which this invention pertains are used to control or throttle high pressure fluid flows such as applications that involve steam flow.

### SUMMARY OF THE INVENTION

The present invention provides a new and improved control valve assembly for controlling or throttling the flow of fluid such as steam.

According to one preferred embodiment of the invention, a flow control valve is provided that includes a valve housing that defines a valving chamber. A port member mounted within the valving chamber receives a reciprocally movable piston/spool assembly. The relative position of the piston/spool assembly within the port member determines the flow rate of fluid through the valving chamber. An actuator is used to move the piston/spool assembly within the port member. The piston/spool assembly is engageable with a valve seat which, when engaged, blocks fluid flow through the valving chamber. An actuating member is operatively connected to the piston/spool assembly and can move the assembly in opening and closing directions within the port member.

According to the invention, the piston/spool assembly includes a piston body that defines a seal recess for receiving an annular seal. The seal sealingly engages an inside surface of the port member and inhibits fluid flow between the piston/spool assembly and the inside surface of the port member. The assembly also includes a bonnet that is received by the piston body and is engageable with the annular seal. The seal, the bonnet and the actuating member are arranged such that when the actuating member moves the piston/spool assembly into sealing contact with the valve seat, forces are exerted on the annular seal by the bonnet which cause increased sealing engagement between the inside surface of the port member and the annular seal.

In the exemplary embodiment, the bonnet applies compression forces to the seal which, in turn, causes the seal to expand in the radial direction, thus increasing its sealing engagement with the inside surface of the port member.

According to a further feature of this embodiment, the actuating member abutably engages the bonnet and is attached to the associated piston body with a connection that allows relative movement between the actuating member and the piston body. With this preferred embodiment, when the actuating member moves the piston/spool assembly into sealing contact with the valve seat, the bonnet, by virtue of the lost motion connection (between the actuating member and the piston body) moves relative to the piston body a slight amount, thus applying forces to the seal that is captured between the bonnet and the piston body. These forces cause at least a portion of the annular seal to expand in the radial direction, thus increasing the sealing contact between the annular seal and the inside surface of the port member.

With the disclosed embodiment, the annular seal engages the inside surface of the port member with increased engagement force only when the piston/spool assembly is moved to a position where it sealingly engages the associated valve seat. When the actuating member moves the piston/spool assembly away from the valve seat, the compression forces applied by the bonnet are released, thereby relaxing the seal and reducing the friction between the seal and the inside surface of the port member. As a result, reciprocal movement of the piston/spool assembly within the port member is not resisted by a substantial frictional force that would be present if the seal were permanently preloaded to exert the substantial sealing engagement that is present when the piston/spool assembly is moved to its valve seat engaging position.

According to a further feature of the invention, a gap is preferably maintained between the bonnet and the piston body. The gap, in cooperation with pressure balancing passages equalizes fluid pressures on the piston/spool assembly.

The preferred method of controlling the flow rate of high pressure fluid in a control valve, includes the steps of providing a valve housing that defines a valving chamber, providing a port member within the valving chamber that receives a reciprocally movable piston/spool assembly. In addition, the method provides a valve seat engageable by the piston/spool assembly for blocking flow through the valving chamber. Enhanced sealing between the piston/spool assembly and an inside surface of the port member is provided by moving the overall assembly within the port member with an actuating member. The actuating member is allowed to move relative to a portion of the piston/spool assembly in order to allow another portion of the piston/spool assembly to move relative to the first portion thereby applying forces to the seal. This causes the seal to expand radially and to increase its sealing engagement with the inside surface of the port member.

With the disclosed invention, sealing between a piston/spool assembly and its associated port member are substantially increased when the piston/spool assembly engages its associated valve seat. When the piston/spool assembly is in a position other than its valve seat engaging position, the seal is relaxed. With the seal relaxed, friction between the seal and port member is reduced. Consequently, the relative movement between the piston/spool assembly and the port member is not substantially resisted by the engagement of the seal with the port member. Thus, the control of the fluid flow rate through the valving chamber is substantially improved.

Additional features of the invention will become apparent and a fuller understanding obtained by reading the following detailed description made in connection with the accompanying drawings.

### BRIEF DESCRIPTION OF THE DRAWINGS

FIG. 1 is a fragmentary sectional view of a prior art valve assembly;

FIG. 1A illustrates an overall view of the type of valve to which this invention pertains;

FIG. 2 is a fragmentary sectional view of a valve assembly constructed in accordance with a preferred embodiment of the invention;

FIG. 3 is a side devotional view of a piston assembly and associated sleeve constructed in accordance with a preferred embodiment of the invention;

FIG. 4 is a sectional view of the assembly shown in FIG. 3, as seen from the plane indicated by the line 4-4 in FIG. 3; and

FIG. 5 is an exploded view of the assembly shown in FIG. 3.

### DETAILED DESCRIPTION

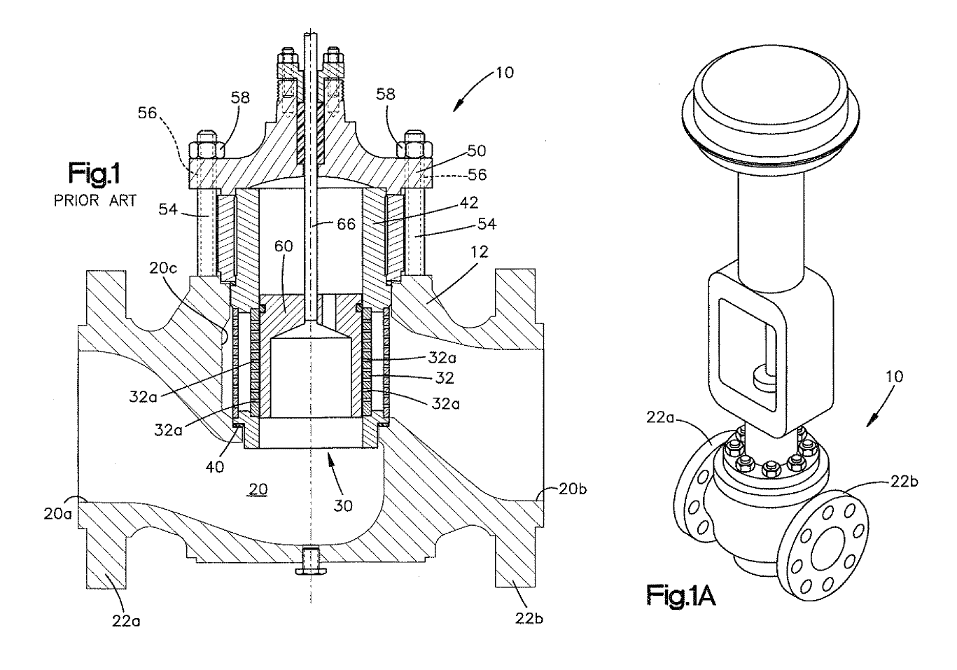

FIG. 1 illustrates, in sectional view, a portion of a prior art valve assembly 10. The valve assembly is termed a balance seal or flow control valve which is used, for example, in the steam industry to control or throttle steam flow. FIG. 1A illustrates an overall view of the type of valve shown in FIG. 1 and that this invention pertains to.

The valve assembly 10 includes a valve housing 12, which includes a flow passage 20 having an inlet end 20a and an outlet end 20b. In the illustrated construction, the inlet and outlet ends 20, 20b define respective bolt flanges 22a, 22b to which suitable piping (not shown) is fastened in a known way.

The flow of fluid (i.e., steam) from the inlet 20a to the outlet 20b is controlled by a valving assembly indicated generally by the reference character 30. The valving assembly 30 includes a ported sleeve 32 that is fixed within a valve chamber 20c also defined by the valve housing 12. In the illustrated construction, the sleeve 32 may be captured within the valve body between a step 40 and a cylindrical spacer 42. A valve cap 50 exerts a clamping force on the sleeve 32. The valve cap 50 is secured by a plurality of studs 54 that extend upwardly from the valve housing 12, extend through bores 56 in the cap 50 and receive suitable nuts 58 which retain the cap in position and apply a clamping force to the cylindrical spacer 42.

A flow control piston or spool 60 is reciprocally movable within the sleeve 32 and when it is moved upwardly, (as viewed in FIG. 1), it uncovers one or more ports 32a defined by the sleeve 32. The more ports 32a that are uncovered, the greater the fluid flow between the inlet 20a and the outlet 20b. The piston/spool 60 is reciprocally movable by an operating stem 66 is which operatively attached to an actuator, one of which is shown in Appendix 1. The actuator is conventional and does not form part of the present invention.

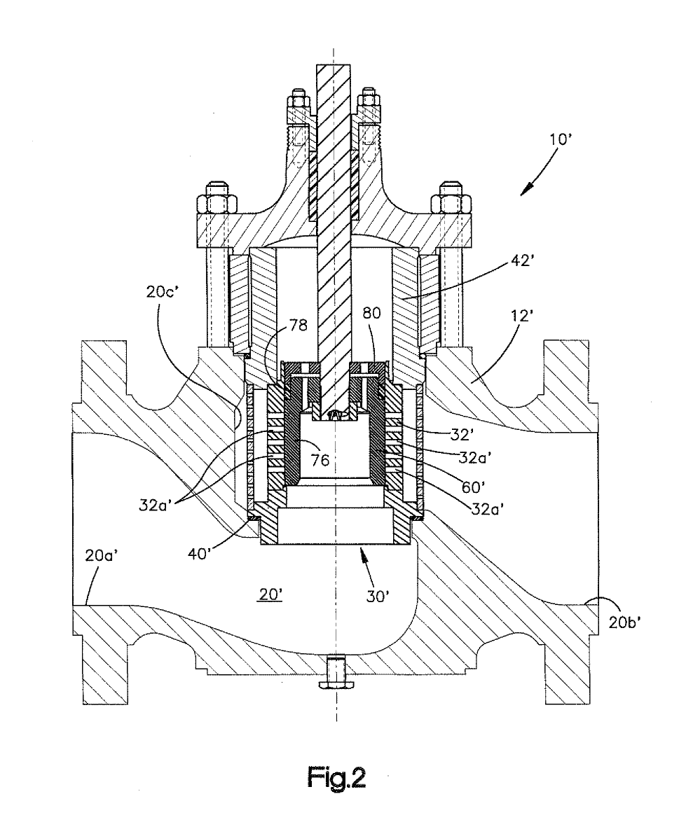

FIG. 2 illustrates a valve assembly 10′ constructed in accordance with a preferred embodiment of the invention. The valve assembly 10′ constitutes a substantial improvement over the valve assembly 10 shown in FIG. 1. To facilitate the explanation, components in FIG. 2 that are the same or perform similar functions as components in FIG. 1 will be given the same reference character followed by an apostrophe.

The valve assembly 10′ includes a valve housing 12′ that defines a flow passage 20′ having an inlet end 20a′, an outlet end 20b′ and a valve chamber 20c′. A valving assembly 30′ constructed in accordance with a preferred embodiment of the invention in located in the valve chamber 20c′ and controls the flow of fluid i.e. steam, from the inlet 20a′ to the outlet 20b′. The valving assembly 30′ includes a ported sleeve 32′ that is clamped between the seat or step 40′ and the annular spacer 42′.

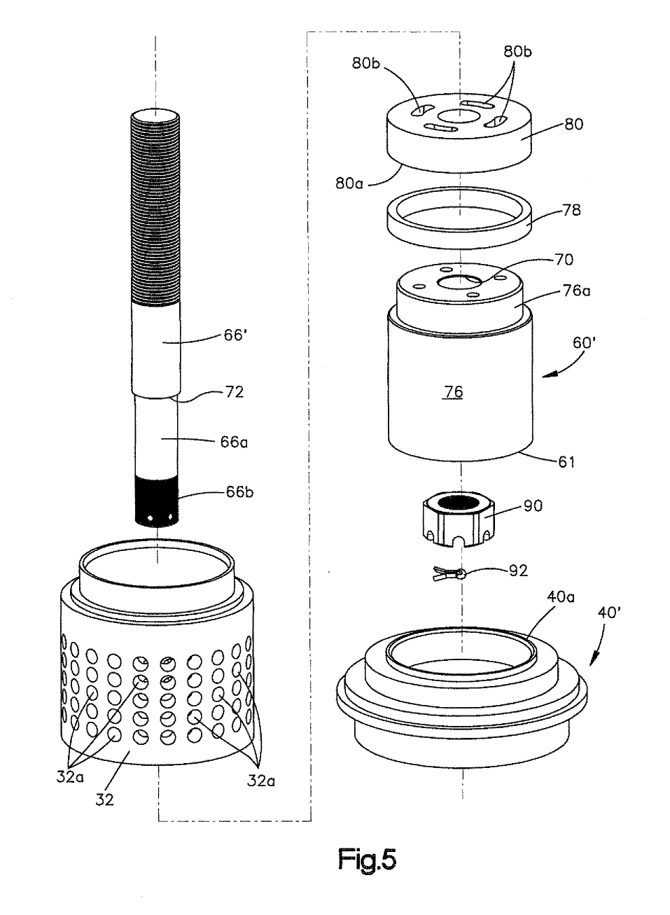

The valving assembly 30′ includes a piston/spool assembly 60′ constructed according to a preferred embodiment of the invention. The piston/spool assembly 60′ is reciprocally movable within the port sleeve 32′ and controls or throttles fluid flow between the inlet 20a′ and outlet 20b′. It should be apparent that the more ports 32a′ that are exposed as the piston/spool assembly 60′ is raised (as viewed in FIG. 2), the greater the flow of fluid, i.e., steam through the valve housing 12′. Referring also to FIGS. 4 and 5, when the piston/spool assembly 60′ is moved to its lowermost position (as viewed in FIG. 2), the lower annular edge 61 of the piston/spool assembly 60′ contacts and sealingly engages an angled seat surface 40a defined by the seat 40′ (shown best in FIG. 5). In this position, the piston/spool assembly 60′ blocks flow through the passage 20.

The piston assembly 60′ includes a piston body 76 having an upper, reduced diameter section 76a which defines an open-ended groove for receiving an annular seal 78. A compression bonnet 80 is at least partially received by the reduced diameter section 76a of the piston body 76 and includes a downwardly depending (as viewed in FIG. 4) axial flange 80a. The lower edge of the axial flange 80a abuts the upper (as viewed in FIG. 4) radial face of the annular seal 78 and can exert compression forces on the seal when the bottom edge 61 of the piston body 76 is moved into sealing contact with the sealing surface 40a of the seat 40″.

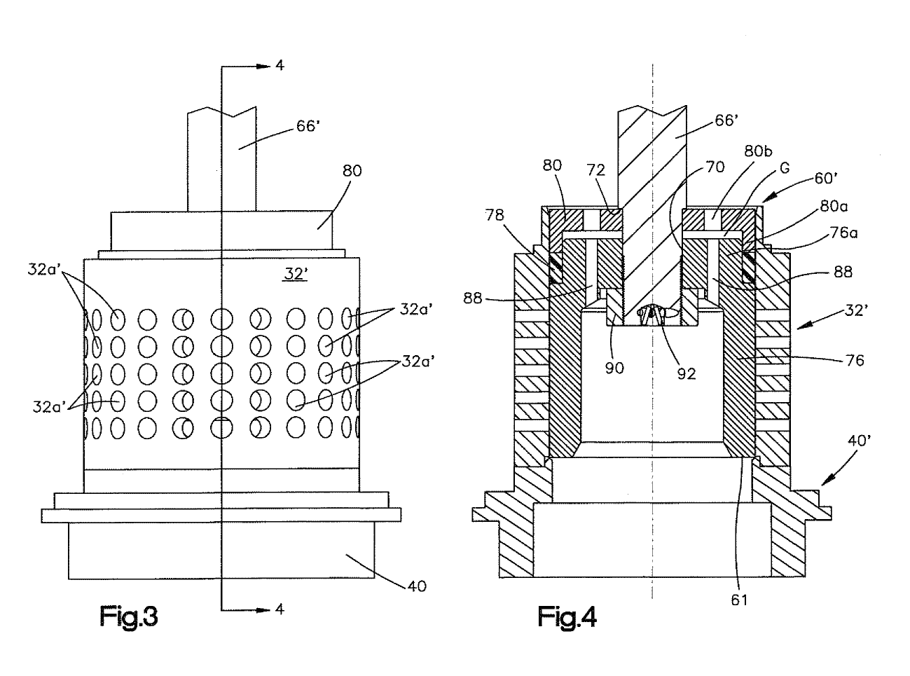

Referring to FIGS. 3-5, the piston/spool assembly 60′ includes a central bore 70 which slidably receives a reduced diameter portion 66a′ of the operating stem 66′. The reduced diameter portion 66a′ defines a step 72, the function of which will be described

When the piston body 76 is in contact with seat 40′ and the stem 66′ continues to be urged downwardly by its associated actuator, the step 72 applies a downward directed force to the top of the compression bonnet 80 and urges it downwardly. This downward force causes the axial rim 80a of the bonnet 80 to exert a compression force on the annular seal 78 and may reduce its axial dimension (depending on the material composition of the seal 78). The compression of the seal 78 in the axial direction causes the seal to expand radially and thus create a tight sealing engagement between the upper part 80a of the piston body 76 and the inside surface of the sleeve 32′, thus inhibiting leakage between the piston body 76 and the sleeve 32.

In the preferred embodiment, the piston body 76 includes pressure-balancing bores 88 and the compression bonnet 80 includes arcuate slots 80b for equalizing fluid pressure above and below the piston assembly 60′ when the piston body 76 is in sealing contact with the associated seat 40′. In this position, fluid flow from the inlet 20a′ to the outlet 20b′ is blocked. Absent the balancing bores 88 and openings 80b in the bonnet 80, full inlet pressure would urge the piston body 76 upwardly, which would tend to move the piston assembly 60′ toward an open position. The communication of inlet fluid pressure to the top surface of the bonnet/80 (as viewed in FIG. 4) balances the force on the piston assembly 60′.

With the disclosed construction, sealing engagement of the piston body 76 to the sleeve 32′ is substantially enhanced without detrimentally affecting the ability of the piston assembly 60′ to be reciprocally moved within the sleeve 32′ by the associated actuator. Downward movement of the stem 66′ (by an associated actuator) causes compression of the annular seal 78 once the bottom edge or skirt 61 of the piston body sealingly contacts the associated seat 40′. As discussed above, compression of the annular seal 78 causes radial expansion, thus causing a tight engagement between the seal 78 and the inside surface of the ported sleeve 32′. However, when the piston body 76 moves off the seat 40′, as the stem 66′ is raised upwardly, the upward movement of the bonnet 80′ (which depending on the material from which the seal 78 is made may be very slight) relaxes the seal 78, thus decreasing the force necessary to reciprocally slide the piston assembly 60′ within the sleeve 32′ to achieve a desired flow rate. With the disclosed invention, when the piston body 76 is off its seat 40′, the piston assembly 60′ can be moved by the actuator relatively easily in order to control the flow rate through the valve. In normal operation, the actuator may continually move or dither the piston assembly 60′ within the sleeve in order to achieve a desired flow rate. In the prior art, the piston seal was fully loaded at all times, thus requiring significant actuator force to reciprocally move the piston within the sleeve even when the piston disengaged the associated seat.

It should be noted here, that the connection of the stem 66′ with the compression bonnet 80′ and piston body 76′ resembles a lost motion connection. In particular, the narrow diameter portion 66a′ of the stem 66′ can move relative to the piston body 76 a predetermined amount in order to relax and compress the seal 78. The distal end 66b of the stem 66′ is threaded and receives a nut 90 by which an initial pre-load is preferably applied to the seal 78 by the compression bonnet 80, to initially compress the seal 78 a minimal amount. When the stem moves downwardly from its relaxed position to its full force applying position shown in FIG. 4, the compression bonnet 80 preferably moves downwardly a slight amount thus slightly reducing the gap “G” between the underside of the bonnet 80 and the top of the piston body 76 to compress the seal 78 and effect the substantial sealing engagement between the seal 78, the inside surface of the ported sleeve 32′ and the upper portion 76a of the piston body 76. It is should be noted here that the compressibility of the seal will determine the extent of movement of the compression bonnet 80 with respect to the piston body 76. Accordingly, the amount that the gap “G” is reduced when the compression bonnet 80 is in the force applying position shown in FIG. 4, will be dependent on the compressibility of the seal material. In the preferred embodiment, however, it is preferred that the material for the seal and the gap “G” is chosen such that there is always some gap between the compression bonnet 80 and the piston body 70 when the seal 78 is fully compressed.

As seen best in FIG. 5, a cotter pin 92 is used to lock the relative rotated position of the preload adjustment nut 90 on the threaded end 66b of the stem 66′.

In the preferred embodiment, a gap G was maintained between the underside of the compression bonnet 80 and the top of the piston body 76. Depending on the material composition of the seal 78, the gap may change slightly or substantially. In any event, in the preferred embodiment, a gap G preferably always exists even when the piston body 76 is in tight sealing engagement with the seat 40a. By maintaining a gap G throughout valve operation, the full downward force applied by the stem 66′ is always applied to the seal, rather than directly to the piston body 76. With this preferred construction, fluid communication between the pressure balancing bores 88 and the arcuate slots 80a is maintained even if the slots are not aligned with the bores 80a. In addition, any wear that occurs in the seal 78 is taken up by slight reductions in the gap G without reducing the forces applied to the seal when the piston body 76 is seated against the seat 40′.

Although the invention has been described with a certain degree of particularity, it should be understood that those skilled in the art can make various changes to it without departing from the spirit or scope of the invention as hereinafter claimed.

Having described the invention, the following is claimed:

1. A flow control valve assembly comprising:
a) a valve housing defining a valving chamber;
b) a port member mounted within said valving chamber;
c) a piston/spool assembly reciprocally movable within said port member, said piston/spool assembly in cooperation with said port member controlling the rate of fluid flow through said valving chamber;
d) an actuator for moving said piston/spool assembly within said port member;
e) a valve seat engageable by said piston/spool assembly whereby fluid flow through said valving chamber is blocked;
f) an actuating member for exerting forces on said piston/spool assembly in order to urge said piston/spool assembly in opening and closing directions within said port member.
g) said piston/spool assembly including:
i) a piston body defining a seal recess for receiving an annular seal, said seal recess configured such that said annular seal carried by said recess sealingly engages an inside surface of said port member, whereby fluid flow between said piston/spool assembly and said inside surface of said port member is inhibited;
ii) a bonnet received by said piston body and operatively engageable with said annular seal such that a valve closing movement in said actuating member causes said bonnet to exert forces on said annular seal to thereby enhance sealing engagement between said inside surface of said port member and said piston/spool assembly.

2. The apparatus of claim 1 wherein said bonnet is a compression bonnet that exerts compression forces on said annular seal under predetermined operating conditions.

3. The apparatus of claim 1 wherein said port member comprises a cylindrical sleeve having a plurality of radially directed ports.

4. The apparatus of claim 2 wherein said compression bonnet defines a gap between itself and said piston body, such that said compression forces exerted by said actuating member are applied directly to said annular seal.

5. The apparatus of claim 1 wherein said actuating member is coupled to said piston/spool assembly through a lost motion connection.

6. The apparatus of claim 2 wherein said piston/spool assembly includes an adjusting member for adjusting a pre-load force applied by said compression bonnet to said annular seal.

7. A piston/spool assembly for a flow rate control valve of the type for controlling high pressure fluid and that includes a port member for slidably receiving said piston/spool assembly, comprising:
a) a piston body defining a seal recess for receiving an annular seal and further defining a seating surface engageable with a seat forming part of said control valve;
b) an annular seal received by said recess and sealingly engageable with an inside surface of said port member;
c) a bonnet for exerting forces on said annular seal that urge at least a portion of said seal radially outwardly, whereby sealing engagement between said inside surface of said port member and said piston body is enhanced;
d) an actuating stem for producing movement in said piston body and for applying forces to said bonnet when said seating surface of said piston body is in seating contact with said seat.

8. The piston/spool assembly of claim 7 further comprising pressure balancing passages for communicating an upstream side of said piston/spool assembly with an actuator side of said piston/spool assembly.

9. The piston/spool assembly of claim 8 wherein said piston body and said bonnet are configured such that a passage is defined between said piston body and said bonnet that forms part of said pressure balancing passages.

10. The piston/spool assembly of claim 9 wherein said passage comprises a gap between said piston body and said bonnet.

11. A method of controlling the flow rate of a high pressure fluid in a control valve, comprising the steps of:
a) providing a valve housing defining a valving chamber;
b) providing a port member mounted within said valving chamber and a piston/spool assembly reciprocally movable within said port member, such that cooperation between said piston/spool assembly and said port member controls the rate of fluid flow through said valving chamber;
c) providing a valve seat for said piston/spool assembly such that moving said piston/spool assembly into sealing contact with said valve seat blocks fluid flow through said valving chamber;
d) controlling the rate of flow through said valving chamber by moving said piston/spool assembly relative to said port member;
e) providing a seal carried by said piston/spool that is engageable with an inside surface of said port member whereby fluid flow between said piston/spool assembly and inside surface of said port member is inhibited;
f) allowing an actuating member operatively connected to said piston/spool assembly to move relative to a portion of said piston/spool assembly when said piston/spool assembly engages said valve seat in order to exert forces on said seal that urge at least portions of said seal into increased sealing engagement with said inside surface of said port member.

12. The method of claim 11 wherein said piston/spool assembly includes a piston body defining a recess for said seal and a bonnet for exerting said forces on said seal.

13. The method of claim 11 wherein said forces comprise compression forces.

14. A flow control valve assembly comprising:
a) a valve housing defining a valving chamber;
b) a port member mounted within said valving chamber;
c) a piston/spool assembly reciprocally movable within said port member, said piston/spool assembly in cooperation with said port member controlling the rate of fluid flow through said valving chamber;
d) an actuator for moving said piston/spool assembly within said port member;
e) a valve seat engageable by said piston/spool assembly whereby fluid flow through said valving chamber is blocked;
f) an actuating member for exerting forces on said piston/spool assembly in order to urge said piston/spool assembly in opening and closing directions within said port member.
g) said piston/spool assembly including:
i) a piston body defining an annular recess for receiving an annular seal, said seal recess configured such that said annular seal carried by said recess sealingly engages an inside surface of said port member, whereby fluid flow between said piston/spool assembly and said inside surface of said port member is inhibited;
ii) a compression bonnet received by said piston body and operatively engageable with said annular seal such that a valve closing movement in said actuating member causes said compression bonnet to exert compression forces on said annular seal to thereby enhance sealing engagement between said inside surface of said port member and said piston/spool assembly.

15. A piston/spool assembly for a flow rate control valve of the type for controlling high pressure fluid and that includes a port member for slidably receiving said piston/spool assembly, comprising:
a) a piston body defining an annular open recess for receiving an annular seal and further defining a seating surface engageable with a seat forming part of said control valve;
b) an annular seal received by said recess and sealingly engageable with an inside surface of said port member;
c) a compression bonnet for exerting compression forces, in an axial direction, on said annular seal whereby sealing engagement between said inside surface of said port member and said piston body is enhanced;
d) an actuating stem for producing movement in said piston body and for applying compression forces to said compression bonnet when said scaling surface of said piston body is in seating contact with said seat;
e) an adjustment member for adjusting an initial compression pre-load on said annular seal.

16. The piston/spool assembly of claim 7 further comprising an adjustment member for adjusting an initial preload on said annular seal.

17. The piston/spool assembly of claim 7 wherein said bonnet exerts compression forces in an axial direction, on said annular seal, which urges at least a portion of said annular seal to expand in the radial direction.
